(19) United States
(12) Patent Application Publication
(10) Pub. No.: US 2010/0148091 A1
(43) Pub. Date: Jun. 17, 2010

(54) METHOD AND SYSTEM FOR RAPID PHASE LUMINESCENSE SPECTROSCOPY ANALYSIS

(75) Inventor: Dwight Sherod Walker, Durham, NC (US)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(73) Assignee: Glaxo Group Limited

(21) Appl. No.: 12/442,972

(22) PCT Filed: Sep. 12, 2007
(86) PCT No.: PCT/US07/78212

§ 371 Date: Mar. 26, 2009

(30) Foreign Application Priority Data
Sep. 29, 2006 (US) 60848069

(51) Int. Cl. G01J 1/58; G01N 21/64

(52) U.S. Cl. 250/459.1; 250/458.1; 250/461.1

(57) ABSTRACT

A system for use in analyzing a pharmaceutical composition having multiple constituents comprising a luminescence sensor, the sensor being adapted to direct a plurality of radiation pulses to the pharmaceutical composition and detect luminescence emitted from each composition constituent as a function of time, the sensor being further adapted to provide at least one luminescence signal corresponding to the detected luminescence of each constituent, and control means in communication with the sensor for controlling the sensor and analyzing the luminescence signal.

### FIELD OF THE INVENTION

The present invention relates generally to spectroscopic systems. More particularly, the invention relates to a method and system for determining the presence and characteristics of pharmaceutical compositions via the fluorescence and phosphorescence characteristics thereof.

### BACKGROUND OF THE INVENTION

A critical step in the preparation of a pharmaceutical composition, which often comprises a plurality of constituents, including one or more of the active drugs, is mixing or blending. Indeed, it is imperative that the pharmaceutical composition is homogenous and has the required density to ensure that the appropriate dosage of the active drug or drugs is delivered to a recipient.

The homogeneity and, of course, constituent concentration of pharmaceutical compositions are thus critical factors that are closely monitored during processing.

Various conventional methods have been employed to determine the homogeneity and constituent concentration of pharmaceutical compositions. Most of the conventional methods are, however, complex and time consuming.

The conventional methods typically involve stopping the blender and removing nine (9) or more samples from various locations in the blender. The samples are then taken to a laboratory and analyzed. The blender remains shut down while the samples are analyzed, which can take from 24 to 48 hours to complete.

Another time consuming aspect of the traditional methods is the hit or miss approach to determine when the mixture is homogeneous. Typically, the blender is run for a pre-determined amount of time. The blender is then stopped and the samples are removed and analyzed. If the mixture is not homogenous, the blender is run again and the testing procedure is repeated.

Further, the mixture may reach homogeneity at a time-point before the pre-determined set time for blending. In the first case more testing is carried out than is required, and in the second case valuable time is wasted in blending beyond the end-point. It is also possible that over blending can cause segregation of the constituents (or components).

Finally, during compaction of the mixture, achieving the target density of the mixture is critical. Indeed, as is well known in the art, achieving the desired (or target) density of the composition is critical to achieving the proper weight and, hence, dose of the product.

Several apparatus and methods have been employed to detect on-line homogeneity. Illustrative are the apparatus and methods disclosed in Co-Pending application Ser. No. 10/363,291, entitled “Method and Apparatus for Detecting On-Line Homogeneity” and PCT Pub. Nos. WO 02/18921 A2 and WO 01/29539 A1.

In PCT Pub. No. WO 01/29539 A1, methods and systems that utilize luminescence to non-invasively analyze one or more components of a mixture are disclosed. In this instance, fluorescence is employed.

Although the disclosed systems overcome several of the above noted drawbacks associated with conventional methods and systems of determining homogeneity and concentration (i.e. potency) of constituents in pharmaceutical compositions, the system has several significant limitations. A major limitation is that the methods and systems are solely based on fluorescent emission from a target element. Because of the short timescale of fluorescence, measurement of the time-resolved emission requires sophisticated and costly optics and electronics. Further limitations are that the system requires fiber optic coupling and utilizes a high current light source.

In Applicant's PCT Application, i.e. PCT Pub. No. 01/29539 A1, a system for real-time fluorescent determination of trace elements is disclosed. The system includes a fluorometer that is adapted to provide two lines of incident radiation (incident radiation pulses). According to the invention, the first line of incident radiation is directed toward and substantially perpendicular to a first sample (i.e. blister strip) and, hence, sample path (designated generally SPi) and the second line of incident radiation is directed toward and substantially perpendicular to a second path (designated generally SP₂). The radiation transmission means can also be adapted to provide one line of incident radiation to facilitate a single (rather than dual) blister strip process.

The first control means of the system generates and provides a plurality of incident radiation pulses of different wavelengths, preferably in the range of 200 to 800 nm. According to the invention, at least a respective one of the samples is illuminated with at least a respective one of the incident radiation pulses as it traverses a respective sample path SPi, SP₂.

Although the noted system similarly overcomes many of the drawbacks associated with conventional methods of determining homogeneity and concentration of constituents in pharmaceutical compositions, the system potentially has several limitations. The limitations include the requirement of fiber optic coupling and synchronization for data collection.

A further limitation of the noted system, as well as most known luminescence systems, is that the luminescence analysis is performed in a predetermined, fixed wavelength domain, i.e. the sample is excited with a magnitude of light, whereby the light is absorbed by the sample and emitted at a wavelength that is shifted to a higher wavelength (i.e. lower energy).

While the noted luminescence analysis (or technique) can be readily employed for analyzing pharmaceutical compositions having a single constituent, it is extremely difficult to determine the absolute concentrations of multiple constituents in a pharmaceutical composition. This is due to the fact that the fluorescence emissions of the constituents are, in many instances, overlapped.

It is therefore an object of the present invention to provide a luminescence method and system for determining the presence and characteristics of a plurality of constituents in a pharmaceutical composition.

It is another object of the present invention to provide a method and system for time-resolved delayed fluorescence and phosphorescence analysis of pharmaceutical compositions.

It is another object of the present invention to provide a luminescence method and system for detecting on-line homogeneity and constituent concentration of pharmaceutical compositions that is readily adaptable to virtually all conventional blenders.

It is another object of the invention to provide a luminescence method and system for detecting on-line mixture density of pharmaceutical compositions that is readily adaptable to virtually all processing apparatus, including conventional mixing, fill and compaction apparatus and systems.

### SUMMARY OF THE INVENTION

In accordance with the above objects and those that will be mentioned and will become apparent below, the invention provides luminescence based systems, apparatus and methods for analyzing mixtures, e.g. powdered pharmaceutical compositions, and, particularly, for analyzing mixtures during processing. The systems and methods utilize luminescence to non-invasively analyze one or more constituents of the pharmaceutical composition. The analysis can provide a variety of compositional information; particularly, during processing, such as the chemical identity of constituents in the pharmaceutical composition, the concentration of the constituents, changes in the physical properties of the constituents and/or composition, the uniformity and density of the pharmaceutical composition and other information.

In one embodiment of the invention, the system for analyzing a pharmaceutical composition having multiple constituents comprises a luminescence sensor, the sensor being adapted to direct a plurality of radiation pulses to the pharmaceutical composition and detect luminescence emitted from each composition constituent as a function of time, the sensor being further adapted to provide at least one luminescence signal corresponding to the detected luminescence of each constituent, and control means in communication with the sensor for controlling the sensor and analyzing the luminescence signals.

In another embodiment of the invention, the system for analyzing a pharmaceutical composition having multiple constituents includes a processing apparatus configured to process the pharmaceutical composition and a luminescence detection system operatively associated with the processing apparatus, the detection system including at least one luminescence sensor that is adapted to direct a plurality of radiation pulses to the pharmaceutical composition and detect luminescence emitted from each constituent as a function of time, the sensor being further adapted to provide at least one luminescence signal corresponding to the detected luminescence of each constituent, and control means in communication with the sensor for controlling the sensor and analyzing the luminescence signals.

According to the invention, the processing apparatus can comprise, without limitation, a bulk active production apparatus, a transportation apparatus (e.g., conveyor), bulk mixing apparatus, fill apparatus, bead coating apparatus, compression apparatus and spray coating apparatus.

Preferably, the detection system is capable of non-invasively analyzing the pharmaceutical composition in real-time during processing of the pharmaceutical composition.

In a preferred embodiment of the invention, the detection system is capable of determining at least one of the following composition parameters: the identity of each pharmaceutical composition constituent, the concentration of each pharmaceutical composition constituent, the homogeneity of the pharmaceutical composition and the density of the pharmaceutical composition.

The method of in-situ analysis of a pharmaceutical composition during processing, in accordance with one embodiment of the invention, comprises the steps of (i) providing a processing apparatus configured to process the pharmaceutical composition, (ii) providing a luminescence detection system operatively associated with the processing apparatus, the detection system including at least one luminescence sensor, the sensor being adapted and positioned to direct a plurality of radiation pulses to the pharmaceutical composition and detect the luminescence emitted from each constituent in the pharmaceutical composition, the sensor being further adapted to provide at least one luminescence signal corresponding to the detected luminescence of each constituent, and control means in communication with the sensor for controlling the sensor, (iii) illuminating the pharmaceutical composition with at least a respective one of the plurality of radiation pulses, (iv) detecting the luminescence emitted from each pharmaceutical composition constituent as a function of time, (v) and determining at least one characteristic of the pharmaceutical composition from the detected luminescence.

As will be appreciated by one having ordinary skill in the art, the present invention provides numerous advantages. Among the advantages is the provision of luminescence based sensors, systems and methods for non-invasively determining the homogeneity of a pharmaceutical composition and/or the concentration of pharmaceutical composition constituents and/or the density of the pharmaceutical composition during processing. As a result, the process is not disturbed by the analysis and, hence, is generally not susceptible to sampling and measurement errors often associated with conventional invasive methods of analysis.

The luminescence methods of the invention, particularly, the observance of the fluorescence decay as a function of time, also provide a unique and effect means of elucidating physical property in materials during processing, which can not be achieved in any other manner.

Further, the luminescence systems of the invention can be employed on-line and in real-time to provide compositional information during processing. This permits adjustment of processing variables and/or processing apparatus to optimize processing of the pharmaceutical processing.

The luminescence sensors of the invention also provide a strong signal, which results in a high sensitivity and specificity than achievable in NIR analysis. This higher sensitivity enables the luminescence sensors, and systems and methods employing same, of the invention to detect trace elements at low concentrations. The higher specificity further facilitates highly accurate identification of pharmaceutical composition constituents.

Further, the luminescence sensors and luminescence detection systems of the invention can be readily employed in conjunction with any number of types of processing apparatus and systems, especially apparatus used in pharmaceutical processing. The luminescence sensors are small in size, portable, and can be readily mounted at a variety of different locations on processing apparatus.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a graphical illustration of the relationship between excitation and emission in a frequency-domain analysis, where the excitation light is modulated sinusoidally at a single modulation frequency (f);

FIG. 2 is a perspective view of one embodiment of the luminescence sensor, according to the invention;

FIG. 3 is a sectioned perspective view of the sensor shown in FIG. 2;

FIG. 4 is a schematic view of one embodiment of a luminescence sensor, illustrating the components thereof, according to the invention;

FIG. 5 is a schematic illustration of the luminescence sensor LED orientation and focal point, according to the invention;

FIG. 6 is a schematic illustration of a luminescence detection system, according to the invention;

FIG. 7 is a perspective view of a blender for processing pharmaceutical compositions incorporating a luminescence sensor, according to one embodiment of the invention;

FIG. 8 is a perspective view of the blending tote for the blender shown in FIG. 7, illustrating the placement of a plurality of luminescence sensors, according to one embodiment of the invention;

FIG. 9 is a perspective view of a portion of a fill apparatus (i.e., compaction system) for processing pharmaceutical compositions incorporating a luminescence sensor, according to one embodiment of the invention;

FIG. 10 is a time correlated fluorescence decay curve for salmeterol;

FIGS. 11A and 11B are further graphical illustrations of the fluorescence decay characteristics for salmeterol;

FIG. 12 is a time correlated fluorescence decay curve for a pharmaceutical composition including salmeterol and fluticasone propionate;

FIGS. 13A and 13B are further graphical illustrations of the fluorescence decay characteristics for the pharmaceutical composition including salmeterol and fluticasone propionate;

FIG. 14 is a time correlated fluorescence decay curve for rosiglitazone;

FIGS. 15A and 15B are further graphical illustrations of the fluorescence decay characteristics for rosiglitazone; and

FIG. 16 is a time correlated fluorescence decay curve for ramipril.

### DETAILED DESCRIPTION OF THE INVENTION

Before describing the present invention in detail, it is to be understood that this invention is not limited to particularly exemplified structures, apparatus, systems, materials or methods as such may, of course, vary. Thus, although a number of apparatus, systems and methods similar or equivalent to those described herein can be used in the practice of the present invention, the preferred apparatus, systems and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains. Further, all publications, patents and patent applications cited herein, whether supra or infra, are hereby incorporated by reference in their entirety.

Finally, as used in this specification and the appended claims, the singular forms “a”, “an”, “the” and “one” include plural referents unless the content clearly dictates otherwise. Thus, for example, reference to “a sensor” includes two or more such sensors; reference to “a constituent” includes two or more such constituents and the like.

### DEFINITIONS

The term “pharmaceutical composition”, as used herein, is meant to mean and include any compound or composition of matter or combination of constituents, which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.), including, but not limited to, analgesics, e.g., codeine, dihydromorphine, ergotamine, fentanyl or morphine; anginal preparations, e.g., diltiazem; ketotifen or nedocromil (e.g., as the sodium salt); antiinfectives, e.g., cephalosporins, penicillins, streptomycin, sulphonamides, tetracyclines and pentamidine; antihistamines, e.g., methapyrilene; anti-inflammatories, e.g., anti-inflammatory steroids, beclomethasone (e.g., as the dipropionate ester), fluticasone (e.g., as the propionate ester), flunisolide, budesonide, rofleponide, mometasone (e.g., as the furoate ester), ciclesonide, triamcinolone (e.g., as the acetonide) or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester; anti-allergics, (e.g., cromoglicate, ketotifen or nedocromil); anti-infectives (e.g., cephalosporins, penicillins, streptomycin, sulphonamides, tetracyclines and pentamidine); bronchodilators, e.g., 3-(4-{[6-({(2i?)-2-hydroxy-2-[4-hydroxy-3-(hydroxymethyl) phenyl]ethyl}amino)hexyljoxy}butyl)benzenesulfonamide, 3-(3-{[7-({(2R)-2-hydroxy-2-[4-hydroxy-3-(hydroxymethyl)phenyl]ethyl}amino) heptyl]oxy}propyl) benzenesulfonamide, 4-{(1R)-2-[(6-{2-[(2,6-dichlorobenzyl)oxy]ethoxy}hexyl) amino]-1-hydroxyethyl}-2-(hydroxymethyl)phenol, 2-hydroxy-5-((1R)-1-hydroxy-2-{[2-(4-{[(2i?)-2-hydroxy-2-phenylethyl]amino}phenyl)ethyl]amino}ethyl) phenylformamide, 8-hydroxy-5-{(1/?)-1-hydroxy-2-[(2-{4-[(6-methoxy-1,1′-biphenyl-3-yl) amino]phenyl}ethyl)amino]ethyl}quinolin-2(1H)-one, albuterol (e.g., as free base or sulphate), salmeterol (e.g., as xinafoate), ephedrine, adrenaline, fenoterol (e.g., as hydrobromide), formoterol (e.g. as fumarate), isoprenaline, metaproterenol, phenylephrine, phenylpropanolamine, pirbuterol (e.g., as acetate), reproterol (e.g., as hydrochloride), rimiterol, terbutaline (e.g., as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, e.g., 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g., as maleate); α₄ integrin inhibitors e.g. (2 S)-3-[4-({[4-(aminocarbonyl)-1-piperidinylcarbonyl}oxy)phenyl]-2-[((2 S)-4-methyl-2-{[2-(2-methylphenoxy)acetyljamino}pentanoyl)amino]propanoic acid (e.g., as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; corticosteroids, e.g., (6α,11β,16α,17α)-6,9-difluoro-17-{[(fluoromethyl) thio]carboπyl}-11-hydroxy-16-methyl-3-oxoandrosta-1,4-dien-17-yl 2-furoate, (6α,11β,16α,17α)-6,9-difluoro-17-{[(fluoromethyl) trio]carbonyl}-11-hydroxy-16-methyl-3-oxoandrosta-1,4-dien-17-yl 4-methyl-1,3-thiazole-5-carboxylate, xanthines, e.g., aminophylline, choline theophyllinate, lysine theophyllinate or theophylline; therapeutic proteins and peptides, e.g., insulin or glucagon.

In addition to those stated above, it will be clear to a person skilled in the art that, where appropriate, the noted medicaments (or constituents) may be used in the form of salts, (e.g., as alkali metal or amine salts or as acid addition salts) or as esters (e.g., lower alkyl esters) or as solvates (e.g., hydrates) to optimize the activity and/or stability of the medicament. It will be further clear to a person skilled in the art that where appropriate, the medicaments may be used in the form of a pure isomer, for example, R-salbutamol or RR-formoterol.

In accordance with the invention, the pharmaceutical composition constituents particularly include anti-allergics, bronchodilators, beta agonists (e.g., long-acting beta agonists), and anti-inflammatory steroids of use in the treatment of respiratory conditions, for example, cromoglicate (e.g. as the sodium salt), salbutamol (e.g. as the free base or the sulphate salt), salmeterol (e.g. as the xinafoate salt), bitolterol, formoterol (e.g. as the fumarate salt), terbutaline (e.g. as the sulphate salt), 3-(4-{[6-({(2R)-2-hydroxy-2-[4-hydroxy-3-(hydroxymethyl) phenyl]ethyl}amino) hexyl]oxy}butyl) benzenesulfonamide, 3-(3-{[7-({(2R)-2-hydroxy-2-[4-hydroxy-3-(hydroxymethyl) phenyl]ethyl}amino) heptyl]oxy}propyl)benzenesulfonamide, 4-{(1R)-2-[(6-{2-[(2,6-dichlorobenzyl)oxy]ethoxy}hexyl)amino]-1-hydroxyethyl}-2-(hydroxymethyl)phenol, 2-hydroxy-5-((1R)-1-hydroxy-2-{[2-(4-{[(2R)-2-hydroxy-2-phenylethyl]amino}phenyl)ethyl]amino}ethyl)phenylformamide, 8-hydroxy-5-{(1R)-1-hydroxy-2-[(2-{4-[(6-methoxy-1,1′-biphenyl-3-yl)amino]phenyl}ethyl)amino]ethyl}quinolin-2(1H)-one, reproterol (e.g. as the hydrochloride salt), a beclomethasone ester (e.g. the dipropionate), a fluticasone ester (e.g. the propionate), a mometasone ester (e.g., the furoate), budesonide, dexamethasone, flunisolide, triamcinolone, tripredane, (22R)-6.alpha., 9.alpha.-difluoro-11.beta., 21-dihydroxy-16.alpha., 17.alpha.-propylmethylenedioxy-4-pregnen-3,20-dione. Other active agents include antidiabetic and antihyperglycemic drugs (e.g., rosiglitazone maleate, metformin hydrochloride), as well as angiotensin-converting enzyme (ACE) inhibitors (e.g., ramipril).

Further constituents include actives or medicaments useful in erectile dysfunction treatment (e.g., PDE-V inhibitors, such as vardenafil hydrochloride, along with alprostadil and sildenafil citrate).

The term “pharmaceutical composition” also encompasses formulations containing combinations of any of actives listed herein. Exemplary actives include, without limitation, salbutamol (e.g., as the free base or the sulphate salt), salmeterol (e.g., as the xinafoate salt), budesonide, formoterol (e.g., as the fumarate salt) in combination with an anti-inflammatory steroid, such as a beclomethasone ester (e.g., the dipropionate) or a fluticasone ester (e.g., the propionate), budesonide, rosiglitazone, ramipril and meformin.

The “pharmaceutical compositions”, alone or in combination with other actives (or agents), typically include one or more added materials or constituents, such as carriers, vehicles, and/or excipients. “Carriers,” “vehicles” and “excipients” generally refer to substantially inert materials that are nontoxic and do not interact with other components of the composition in a deleterious manner. These materials can be used to increase the amount of solids in particulate pharmaceutical compositions. Examples of suitable carriers include water, fluorocarbons, silicone, gelatin, waxes, and like materials. Examples of normally employed “excipients,” include pharmaceutical grades of carbohydrates including monosaccharides, disaccharides, cyclodextrins, and polysaccharides (e.g., dextrose, sucrose, lactose, raffinose, mannitol, sorbitol, inositol, dextrins, and maltodextrins); starch; cellulose; salts (e.g., sodium or calcium phosphates, calcium sulfate, magnesium sulfate); citric acid; tartaric acid; glycine; low, medium or high molecular weight polyethylene glycols (PEG's); pluronics; surfactants; and combinations thereof.

One additional component that can be employed in a pharmaceutical composition is one or more “derivatized carbohydrates”. The term “derivatized carbohydrates” is used herein to describe a class of molecules in which at least one hydroxyl group of the carbohydrate group is substituted with a hydrophobic moiety via either ester or ethers linkages. All isomers (both pure and mixtures thereof) are included within the scope of this term. Mixtures of chemically distinct derivatised carbohydrates may also be utilized. Suitably, the hydroxyl groups of the carbohydrate can be substituted by a straight or branched hydrocarbon chain comprising up to 20 carbon atoms, more typically up to 6 carbon atoms. The derivatized carbohydrates can be formed by derivitisation of monosaccharides (e.g. mannitol, fructose and glucose) or of disaccharides (e.g. maltose, trehalose, cellobiose, lactose and sucrose). Derivatized carbohydrates are either commercially available or can be prepared according to procedures readily apparent to those skilled in the art.

Non limiting examples of derivatized carbohydrates include cellobiose octaacetate, sucrose octaacetate, lactose octaacetate, glucose pentaacetate, mannitol hexaacetate and trehalose octaacetate. Further suitable examples include those specifically disclosed in patent application WO 99/33853 (Quadrant Holdings), particularly trehalose diisobutyrate hexaacetate. A particularly preferred derivatized carbohydrate is α-D cellobiose octaacetate. Typically, the aerodynamic size of the derivatized carbohydrates will be between 1 and 50 μm, and more particularly 1-20 μm. The derivatized carbohydrates for use in the preparation of compositions in accordance with this invention are typically micronized but controlled precipitation, supercritical fluid methodology and spray drying techniques familiar to those skilled in the art may also be utilized. Suitably the derivatised carbohydrate is present in a concentration of 0.01-50% by weight of the total composition, preferably 1-20%. Other carriers such as, for example, magnesium stearate, can also be used in the formulations.

The term “constituent” as used herein, thus means and includes any of the aforementioned medicaments, actives, drugs, bioactive agents, biopharmaceuticals, carriers and/or excipients and carbohydrates.

The term “during processing”, as used herein, refers to any time during the production of a product from initial product component/ingredient formulation to final product delivery. “During processing” thus includes process development efforts, as well as, commercial manufacturing processes.

The term “active processing steps,” as used herein, refers to steps which involve actual processing of a pharmaceutical composition. In pharmaceutical processing, active processing steps can include bulk active production steps, bulk formulation steps (e.g., mixing, transportation, and the like) and fill and finishing steps (tablet and/or capsule formation). Active processing can additionally include bead coating and compression, and spray coating of an active on a medicament core.

The term “non-invasive,” as used herein, describes a measurement technique that does not require stopping or slowing down an active processing step while taking the measurement.

The term “on-line”, as used herein, means and includes data acquisition directly from a processing apparatus or during an active processing step.

The term “real-time”, as used herein, means and includes substantially simultaneously processing data as the data is received.

The term “luminescence”, as used herein, means the emission of light from a pharmaceutical composition and/or a constituent thereof. As is well known in the art, “luminescence” is the emission of light from excited electronic states of luminescent atoms or molecules (i.e. “luminophores”).

Luminescence generally refers to all emission of light, except incandescence, and may include photohliminescence, chemiluminescence, and electrochemiluminescence, among others. In photoluminescence, which includes fluorescence and phosphorescence, the excited electronic state is created by the absorption of electromagnetic radiation. In particular, the excited electronic state is created by the absorption of radiation having an energy sufficient to excite an electron from a low-energy ground state into a higher-energy excited state. The energy associated with the excited state subsequently can be lost through one or more several mechanisms, including production of a photon through fluorescence, phosphorescence, or other mechanisms.

Luminescence analysis can employ time-independent (steady-state) and/or time-dependent (time-resolved) properties of the luminescence. Time-resolved analyses are generally more informative than steady-state assays.

Applicant has found that time-resolved luminescence analysis can be readily employed to study the temporal properties of a pharmaceutical sample, i.e. pharmaceutical composition. These temporal properties include properties describing the time evolution of the sample and/or components of the sample, including the time-dependent luminescence emission.

The properties also include coefficients for describing such properties, such as the luminescence lifetime, i.e. the average time that a luminophore spends in the excited state prior to returning to the ground state, and the rotational (or more generally the reorientational) correlation time.

As is known in the art, time-solved luminescence can be measured using “time-domain” and/or “frequency-domain” techniques, which involve monitoring the time course of luminescence emission in time space and frequency space, respectively.

In a time-domain measurement, the time course of luminescence is monitored directly, in time space. Typically, a sample containing a luminescent constituent (e.g., active) is illuminated using narrow pulse of light, and the dependence of the intensity of the resulting luminescence emission is observed. For a simple luminophore, the luminescence commonly follows a single-exponential decay, so that the luminescence lifetime can (in principle) be determined from the time required for the intensity to fall to 1/e of its initial value.

In a frequency-domain measurement, the time course of luminescence is monitored indirectly, in frequency space. Typically, the sample is illuminated using intensity-modulated incident light, where the modulation may be characterized by a characteristic time, such as a period. Almost any modulation profile can be used for frequency-domain analysis. However, since virtually any modulation profile can be expressed as a sum of sinusoidal components using Fourier analysis, frequency-domain analysis may be understood by studying the relationship between excitation and emission for sinusoidal modulation.

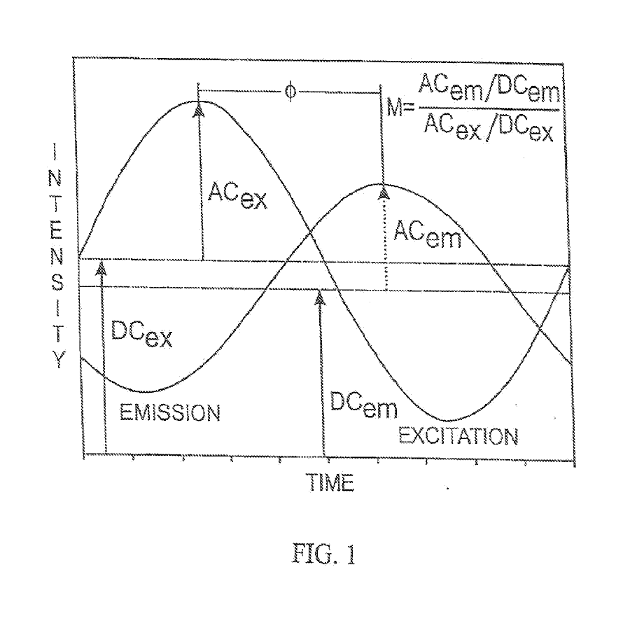

Referring to FIG. 1, there is shown the relationship between excitation and emission in a frequency-domain experiment, where the excitation light is modulated sinusoidally at a single modulation frequency (f). The resulting luminescence emission is modulated at the same frequency as the excitation light. However, the intensity of the emission will lag the intensity of the excitation by a phase angle (phase) φ and will be demodulated by a demodulation factor (modulation) M. Specifically, the phase φ is the phase difference between the excitation and emission, and the modulation M is the ratio of the AC amplitude to the DC offset for the emission, relative to the ratio of the AC amplitude to the DC offset for the excitation. The phase and modulation are related to the luminescence lifetime τ by the following equations:

ωτ=tan(φ)

ωτ=√(1/M²)−1

where ω is the angular modulation frequency, which equals 2π times the modulation frequency.

Significantly, unlike in time-domain measurements, the measured quantities (phase and modulation) are directly related to the luminescence lifetime. For maximum sensitivity, the angular modulation frequency is typically approximately the inverse of the luminescence lifetime.

Typical luminescence lifetimes vary from less than about 1 nanosecond to greater than about 10 milliseconds. Therefore, in some embodiments of the invention, the luminescence systems are configured to cover modulation frequencies from less than about 20 Hz to greater than about 200 MHz.

An advantage of frequency-domain analysis is that multiple detector phase angles can be used instead of or in addition to multiple wavelengths to generate sufficient algorithms for the determinations of multiple unknown concentrations. Even components with identical spectra can be simultaneously determined by the use of different detector phase angles; provided, they have sufficiently different fluorescence lifetimes.

As indicated above, the present invention provides luminescence-based systems and methods for analyzing pharmaceutical compositions (and mixtures thereof) on-line and in real-time. More particularly, the invention is directed to using luminescence to obtain compositional information relating to the pharmaceutical composition, such as the identity of one or more constituents in the composition, the concentration of constituents and the uniformity and/or density of the pharmaceutical composition.

Various types of processing equipment, as described further below, can be configured to non-invasively analyze a pharmaceutical composition and/or mixtures thereof during processing using the luminescence sensors, systems and methods of the invention. As will be appreciated by one having ordinary skill in the art, the systems and methods of the invention can also be used to analyze any number of different forms of mixtures (e.g., solids, slurries, etc.) and different components thereof.

As discussed in detail herein, in one embodiment of the invention, the luminescence of multiple constituents or components (e.g., actives) of a pharmaceutical composition are induced by exposing the composition to light radiation. The luminescence emission from each constituent is then observed as a function of time.

As will be appreciated by one having ordinary skill in the art, virtually any type of electro-magnetic radiation can be employed to induce luminescence. Preferably, ultraviolet and/or visible light is employed to induce luminescence.

As is known in the art, after inducing luminescence each constituent would exhibit (or produce) a characteristic luminescence spectra depending upon its electronic structure. As is also well known in the art, the luminescence spectra provide various information regarding the composition of the material.

Luminescence analysis has several features and, hence, advantages which makes it particularly suitable for use in the systems and methods of the present invention. A key advantage is that luminescence analysis can be conducted non-invasively and, thus, processes do not have to be stopped or slowed in any manner during the analysis. In addition, luminescence analysis is a non-destructive technique; that is, the technique does not consume any material. Therefore, the composition of the material or mixture is generally unaffected by the analysis.

Luminescence analysis also provides a strong luminescence signal that can result in high-detection sensitivity. Consequently, small concentrations of constituents, in some instances, down to 0.1% or lower of the total mixture by weight, can readily be measured using the luminescence sensors and systems of the invention.

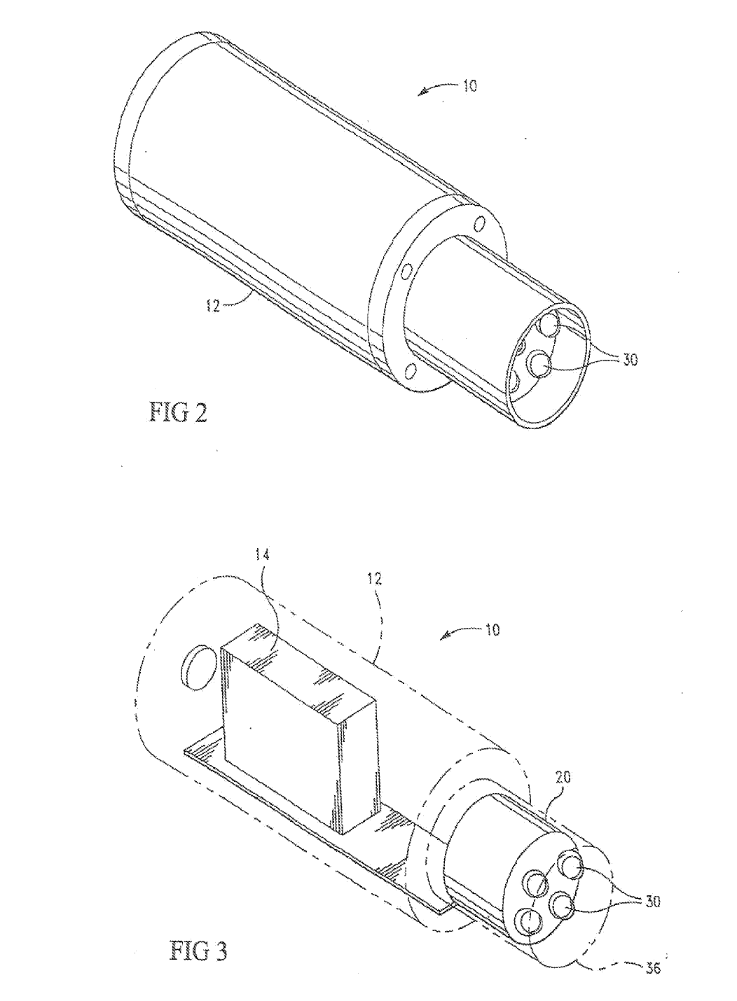

Referring now to FIGS. 2-4, there is shown one embodiment of a luminescence sensor 10 of the invention that can be employed to conduct multiple constituent assessments. As illustrated in FIG. 2, the sensor 10 generally includes an outer housing 12, a photomultiplier tube 20, a plurality of light emitting diodes (LEDs) 30 and a window 36, preferably, a sapphire window.

According to the invention, the housing 12 can comprise a single unit or a two piece unit, as shown in FIG. 2. The housing 12 can also comprise various light-weight, high strength materials, such as stainless steel, Inconel® and Hatstelloy®. In a preferred embodiment of the invention, the housing 12 comprises 316 stainless steel.

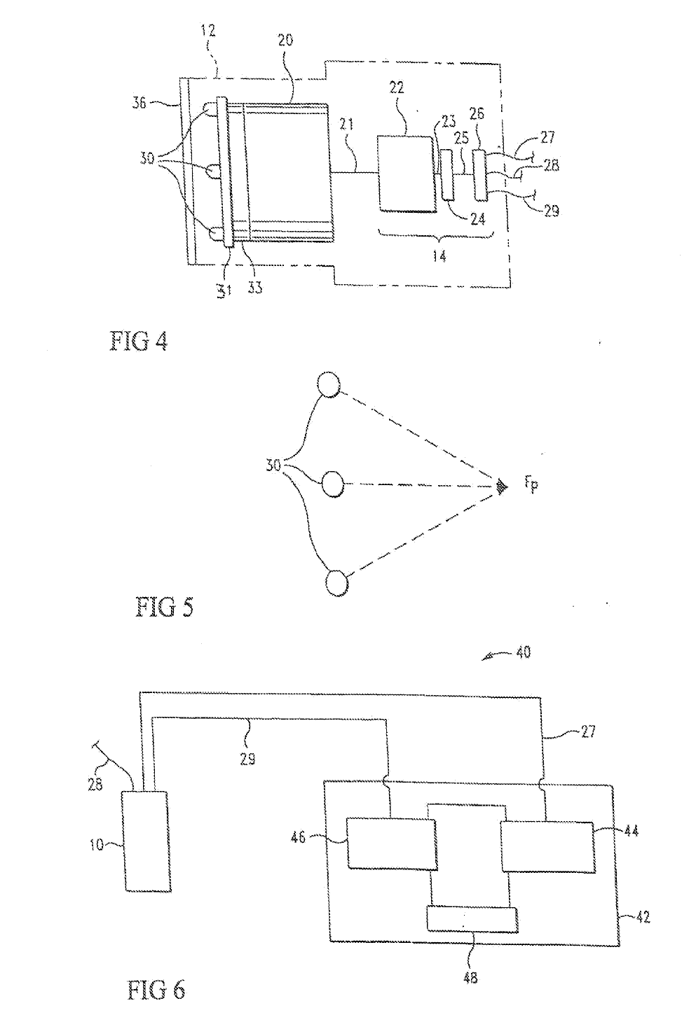

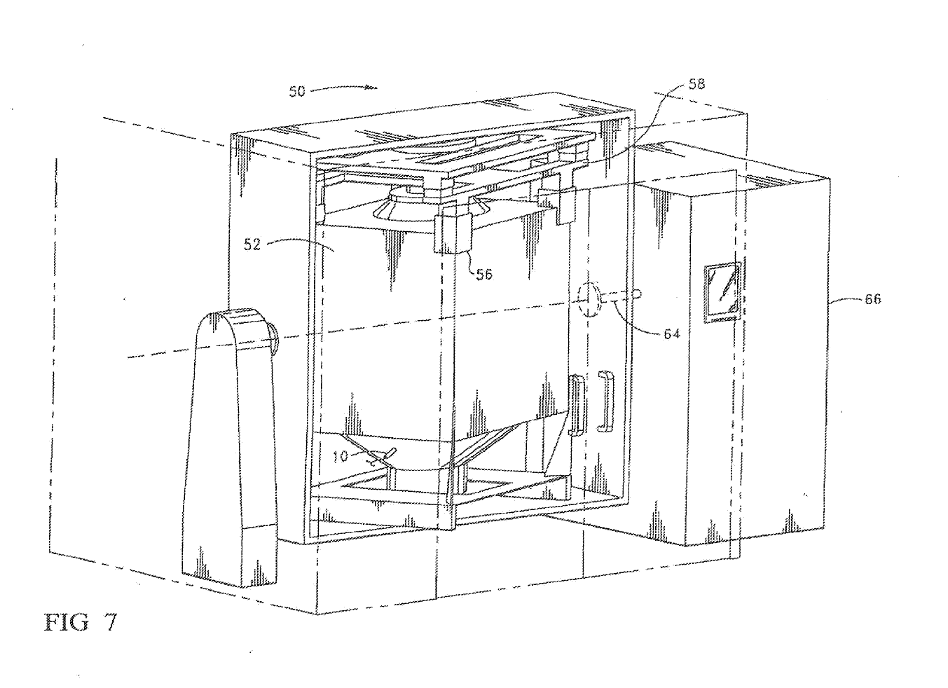

Referring now to FIGS. 3-5, the electronic system and related circuitry for the sensor 10 will be described in detail. Referring first to FIGS. 3 and 4, the sensor 10 includes a photomultiplier tube (PMT) 20, a high voltage power supply 22, which is in communication with the PMT 20 via line 21, a pulse generating circuit 24, which is in communication with the power supply 22 via line 23, a drive electronics circuit 26, which is in communication with the pulse generating circuit 26 via line 25, and power 27, ground 28 and signal 29 leads that are each in communication with the drive circuit 26.

In one embodiment of the invention, an on-off switch (not shown) is connected to the power supply 22 via power lead 27 to control activation of the sensor 10. In preferred embodiments, the on-off switch is designed to activate the sensor 10 based on a predetermined position or positions of the processing apparatus, e.g., position of blender during its rotation cycle. Such switches are well known in the art and generally include a position-detection mechanism. In another aspect, the on-off switch is designed to activate at predetermined time intervals. In another aspect, the on-off switch is designed to activate the sensor based on a predetermined position of the processing apparatus and/or predetermined time interval(s).

In a preferred embodiment of the invention, the sensor 10 is controlled by the control means 42 of the invention. As discussed in detail below, the control means 42 preferably includes a control module 44 and an analyzer 46.

As is well known in the art, the PMT 20 provides several stages of amplification of incident photons via secondary emission from enclosed anodes. As discussed below, the PMT 20 detects the luminescence radiation and converts the signal to a voltage, which preferably is further processed by the analyzer 46.

As illustrated in FIG. 4, disposed proximate the forward end of the PMT 20 are a plurality of LEDs 30 that are preferably disposed on a circuit board 31. Disposed between the PMT 20 and circuit board 31 is a first visible filter 33, preferably, a yellow visible filter.

According to the invention, various high voltage power supplies 22 can be employed within the scope of the invention. Preferably, the high voltage power supply 22 provides in the range of approximately 100-900 volts, more preferably, in the range of approximately 300-600 volts.

Similarly, various LEDs 30 can be employed within the scope of the invention. Preferably, the LEDs 30 comprise blue light emitting diodes having a low wavelength, i.e. in the range of approximately 200-800 nm, more preferably, in the range of approximately 300-650 nm, and a power output in the range of 1-200 milliwatts, more preferably, in the range of 2-5 milliwatts. Applicants have found that the blue light emitting diodes provide sufficient power in the absorbance region of active pharmaceutical compositions to induce luminescence emission.

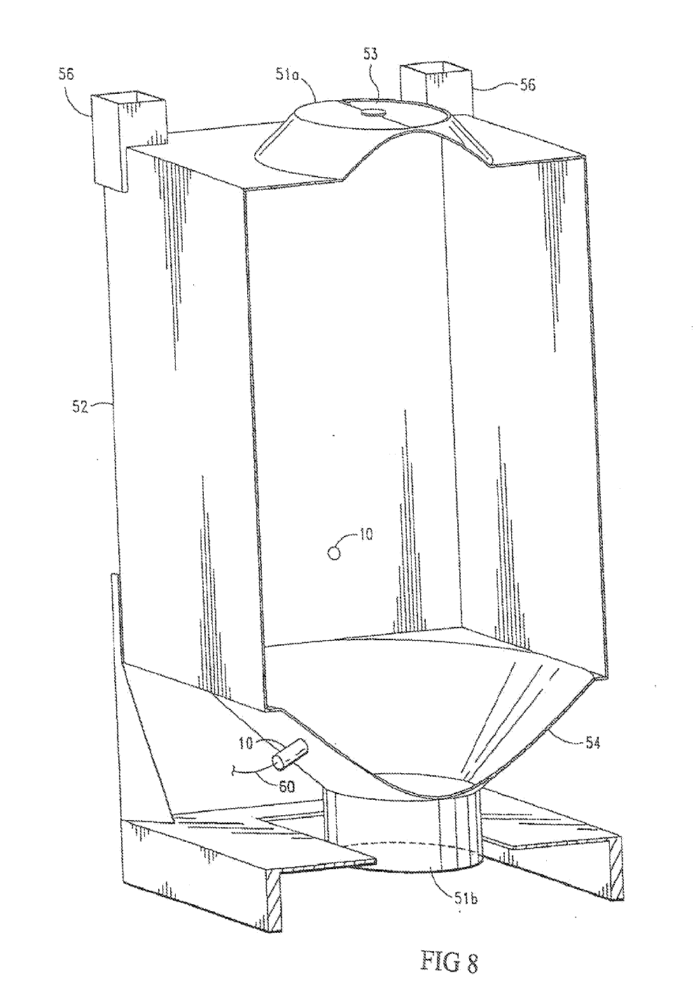

Referring now to FIG. 5, by employing low wavelength blue LEDs 30 having reasonable power (e.g., 2 milliwatts) and a low beam divergence (e.g., approx. 10°), a plurality of LEDs 30 can be focused onto a common point (designated “Fₚ”) to provide the desired illumination.

As illustrated in FIG. 3, in a preferred embodiment, four (4) LEDs 30 are employed. Preferably, the LEDs 30 are disposed in a substantially circular pattern and are focused on a point (Fₚ) in the range of approximately 2-40 mm from the face of the LEDs 30. More preferably, the focal point, Fₚ, is in the range of approximately 5-20 mm from the face of the LEDs 30.

As will be appreciated by one having ordinary skill in the art, additional LEDs can be employed to provide an enhanced focal point, Fₚ, and/or enhance the excitation illumination. As indicated, in a preferred embodiment of the invention, a yellow visible filter 33 is disposed between PMT 20 and LEDs 30 to reduce reflected excitation illumination. Although various filters can be employed within the scope of the present invention, applicants have found that the yellow visible filter 33 provides optimum filtration (or blocking) of the illumination pulse while allowing the desired signal to pass therethrough.

According to the invention, the pulse generating circuit 26 is designed and adapted to provide a pulsed power input to the power supply 22 and, hence, PMT 20. In one embodiment, the pulse generating circuit 26 provides a pulsed cycle in the range of 1-1000 Hz, more preferably, in the range of 4-100 Hz.

In another embodiment of the invention, the pulse generating circuit is adapted to provide modulated frequencies from less than approximately 20 Hz to greater than approximately 200 MHz.

As will be appreciated by one having ordinary skill in the art, the noted pulsed power input will reduce luminescence quenching of the sample. The operating life of the LEDs 30 will also be enhanced. As illustrated in FIG. 3, the noted sensor components and related electronic are disposed in housing 12. Preferably, the components and electronics are hermetically sealed in the housing 12.

By virtue of the minimal, small electronics employed the size of the housing 12 and, hence, sensor 10 is typically less than 20 cm in length and 5 cm in diameter. More preferably, the sensor 10 has a length less than 8.0 cm and a diameter less than 2.5 cm.

A key advantage of the sensor 10 of the invention is thus that the sensor 10 can be readily disposed in a 1 in. port on a blender (or mixer) or other processing equipment. Further, only a small DC voltage in the range of 5-10 volts is required for operation of the sensor 10. Further details of the sensor 10 are set forth in PCT Appl. No. US2005/032421 (Pub. No. WO 2006/036522), which is incorporated herein in its entirety.

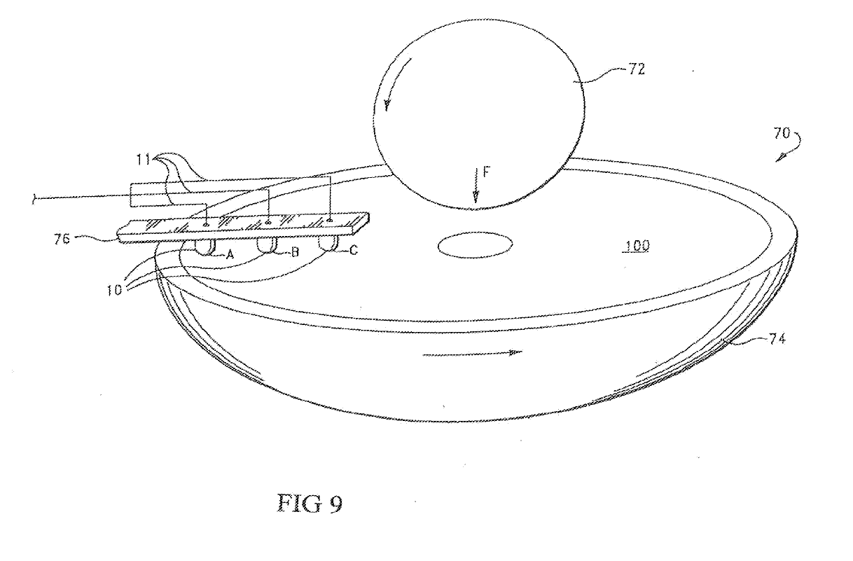

Referring now to FIG. 6, there is shown a schematic illustration of one embodiment of a luminescence detection system (designated generally 40) of the invention. The detection system 40 generally comprises the luminescence sensor 10, which is adapted to provide incident radiation to a pharmaceutical composition (or mixture) and detect the luminescence (emission) radiation from constituents of the composition as a function of time (i.e. time space) and, control means 42.

As illustrated in FIG. 6, the control means 42 preferably includes a control module 44 for controlling the power transmitted to the sensor 10 via power lead 27, timing means for measuring the fluorescence decay as a function of time, an analyzer 46 for analyzing the emission radiation of each constituent detected by the sensor 10, which is communicated to the analyzer 46 via signal lead 29, and storage means 48 adapted to store detected emission radiation and, in some embodiments, luminescence characteristics of known elements (or constituents) for comparison to detected emission radiation.

In a preferred mode of operation, the system 40 is activated and a power input in the range of approximately 5-25 volts is transmitted to the sensor 10, thus activating the LEDs 30, whereby the subject composition (or mixture) is illuminated with incident radiation pulses.

In one embodiment, the subject composition (or mixture) is illuminated with incident radiation over a pre-determined, suitable range of wavelengths (e.g., 200-800 nm) capable of inducing a luminescence response in at least one, preferably, multiple target constituents (or elements). Applicant has found that the noted incident radiation wavelength range will induce a definitive luminescence response in trace elements and, in particular, active constituents, having a relative concentration in the range of 0.3-0.5%.

In response to the incident radiation, each constituent emits luminescent radiation, a portion of which is filtered (via filter 33) and detected by the PMT 20 within a predetermined time space (e.g., 1 second). The luminescence signal is then converted to a DC voltage and transmitted to the analyzer 46, wherein the voltage signal is processed to determine the desired compositional information (e.g., active identification, active content, etc.). The compositional information can further be employed as a signal in a closed-loop control system to actively control one or more of the processing steps or apparatus.

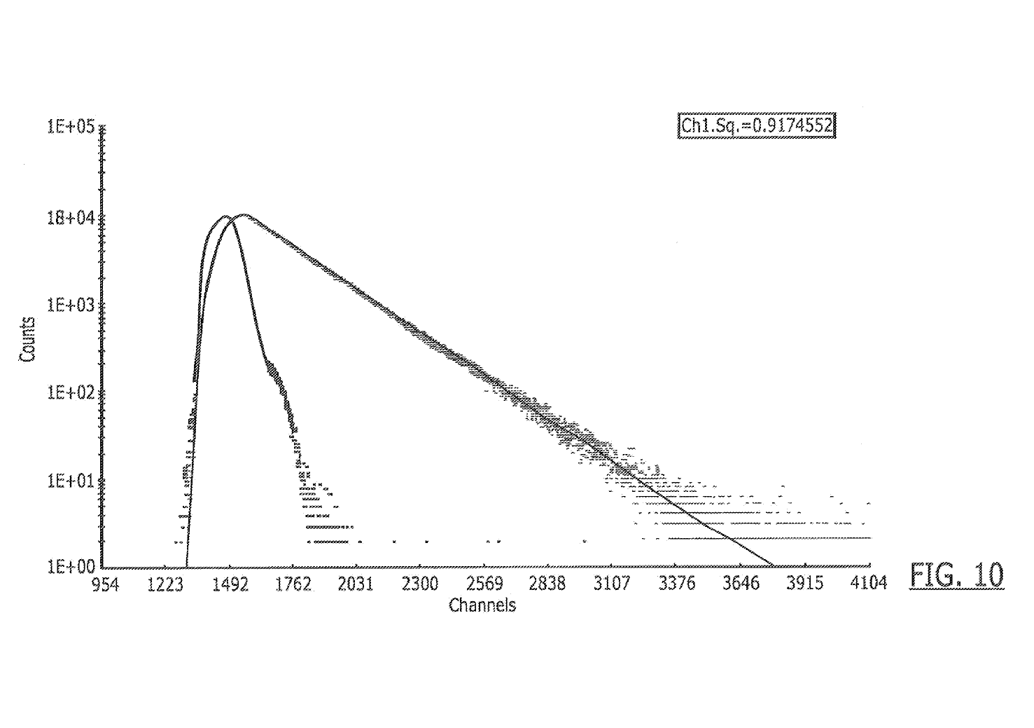

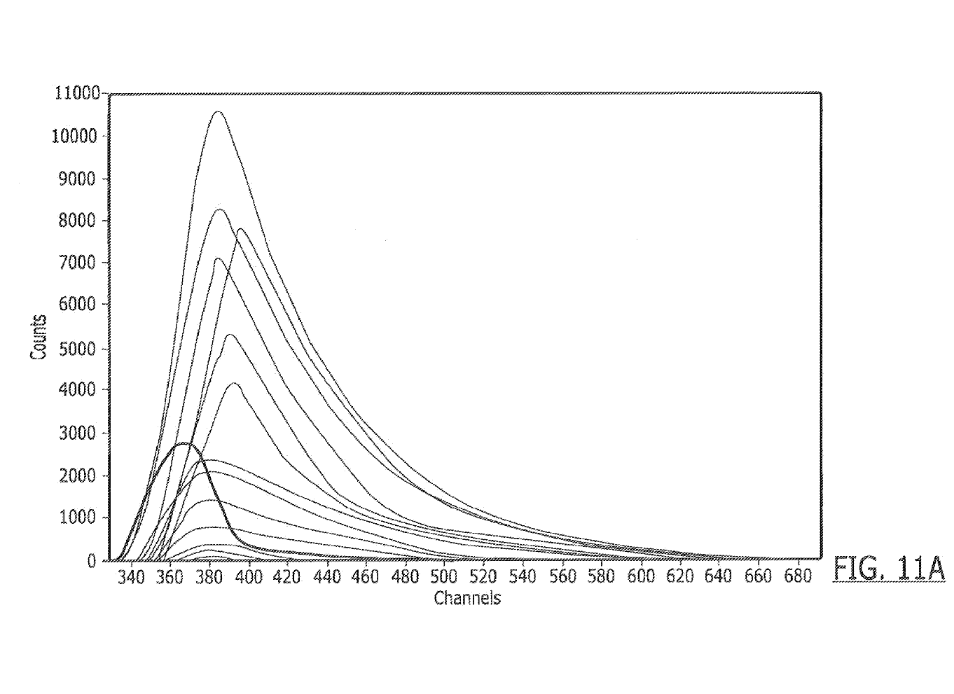

Referring now to FIGS. 7 and 8, there is shown one illustrated embodiment of a processing apparatus incorporating a luminescence sensor 10 of the invention. As illustrated in FIG. 7, in this instance, the processing apparatus comprises a “tote” blending system 50. The blending system 50 is designated and configured to mix compositions of matter, such as powders or liquids, by rotating a “blending tote” 52 containing the composition of matter about an axis of rotation. The tote 52 typically has a height (H) in the range of 55″ in. to 65″ in. and is adapted to hold approximately 1586 liters of matter.

Referring to FIG. 8, the blending tote 52 includes a substantially rectangular section 54 and a substantially tapered section 56 disposed on the bottom end thereof. The tote 52 also includes a first opening 51a at the top of the tote 52 that is generally employed to charge the tote 52 with the individual compositions of matter that are to be mixed (or blended) and a second opening 51b at the bottom of the tote 52 that is generally employed to discharge the mixed, homogeneous composition. Openings 51a, 51b are covered and sealed during the mixing process by a conventional butterfly 53 or cone valves. The tote 52 further includes a plurality of corner posts 56 adapted to removeably engage the mixer clamping frame 58.

Further details of the basic blending system 50 and the components, operation and control thereof are set forth in Co-Pending application Ser. No. 10/363,291; which is incorporated by reference herein in its entirety.

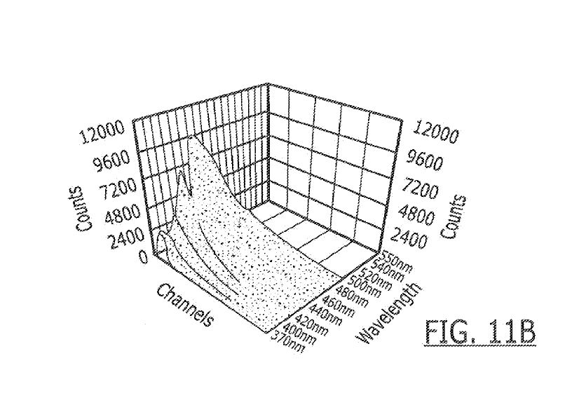

Referring now to FIG. 9, there is shown a schematic illustration of a further processing apparatus incorporating a luminescence sensor 10 of the invention. As illustrated in FIG. 9, in this instance, the processing apparatus comprises a fill apparatus having a composition compactor system or compactor 70.

The compactor 70 is designed and configured to compact and, hence, provide the desired bulk density of powder pharmaceutical compositions. As is well known in the art, during packaging of powered pharmaceutical compositions, the bulk density of the compositions needs to be held at or near constant to ensure that the proper amount of the composition is placed into each dose (e.g., blister). To maintain the bed density and uniformity a roller 72 is employed to apply a force (designated by Arrow “F”) to the powder bed (i.e., composition) 100.

Referring back to FIG. 9, the powder bed 100 is typically disposed in a rotatable compactor container 74. As the container 74 rotates, the roller 72 similarly rotates and applies a compaction force to the composition 100. Further details of the fill apparatus are set forth in U.S. Pat. No. 5,187,921; which is expressly incorporated herein in its entirety.

To provide a real-time assessment of the density of the composition, at least one, preferably, a plurality of luminescence sensors 10 are disposed proximate the bed surface. As illustrated in FIG. 9, in a preferred embodiment, three (3) sensors 10 are employed. The sensors 10 are preferably disposed in a linear pattern extending from the outer periphery of the bed 100 toward the center of the container 74.

According to the invention, the frequency of the luminescence excitation (or cycle time) for each sensor 10 can be similar or different, depending on the residence time of the samples in the system's viewing area. In one embodiment, the pulse for each sensor 10 is as follows: Sensor A=approximately 5-10 Hz; Sensor B=approximately 50-55 Hz; and Sensor C=approximately 95-100 Hz.

The sensors 10 are preferably maintained in the desired positions via a sensor arm or member 76. The leads 27, 28, 29 (designated generally 11) for each sensor 10 are similarly routed to the detection system control means 42.

By virtue of the strategically placed sensors, a closed-loop control system can be employed, wherein a “variable” force can be provided by the roller 72 and applied to the bed 100 to ensure a uniform and accurate composition density.

As will be appreciated by one having ordinary skill in the art, the luminescence sensor 10 (or sensors 10) can similarly be employed on a variety of additional processing apparatus, such as fill apparatus, e.g., the blister strip fill apparatus and process disclosed in PCT Pub. No. WO 02/18921 A2; which is expressly incorporated by reference herein in its entirety, a bulk active processing apparatus, a transportation apparatus (e.g., conveyor), bead coating apparatus, compression apparatus and spray coating apparatus

In accordance with one embodiment of the invention, the system for analyzing a pharmaceutical composition having multiple one constituents comprises a luminescence sensor having an integral low current light source, the sensor being adapted to direct a plurality of radiation pulses to the pharmaceutical composition and detect luminescence emitted from each composition constituent as a function of time, the sensor being further adapted to provide at least one luminescence signal corresponding to the detected luminescence of each constituent, and control means in communication with the sensor for controlling the sensor and analyzing the luminescence signals.

In one embodiment of the invention, the light source comprises a plurality of light emitting diodes.

In one embodiment of the invention, the light source comprises four light emitting diodes. Preferably, each of the light emitting diodes comprises a blue light emitting diode. In a preferred embodiment, each of the light emitting diodes has a wavelength in the range of approximately 300-650 nm and a power output in the range of approximately 2-5 milliwatts.

In one embodiment, the sensor includes a pulse generating circuit adapted to provide a pulsed cycle power input to the light source in the range of approximately 1-1000 Hz.

In one embodiment, the control means includes a control module adapted to control the activation of, power input to and timed measurement of fluorescence emission by the sensor, and an analyzer for analyzing the measured luminescence emission characteristics and generating at least one luminescence signal or value corresponding to at least one of the measured luminescence characteristics.

Preferably, the control means further includes storage means for storing the luminescence measured luminescence characteristics and luminescence signals or values.

In another embodiment of the invention, the system for use in analyzing a pharmaceutical composition having multiple constituents includes a processing apparatus configured to process the pharmaceutical composition and a luminescence detection system operatively associated with the processing apparatus, the detection system including at least one luminescence sensor, the sensor being adapted to direct a plurality of radiation pulses to the pharmaceutical composition and detect luminescence emitted from each constituent as a function of time, the sensor being further adapted to provide at least one luminescence signal corresponding to the detected luminescence of each constituent, and control means in communication with the sensor for controlling the sensor and analyzing the luminescence signals.

In one embodiment of the invention, the processing apparatus comprises a mixing apparatus.

In another embodiment of the invention, the processing apparatus comprises a fill apparatus.

In one embodiment, the processing apparatus comprises an apparatus adapted to transport the pharmaceutical composition during processing.

In one embodiment, the detection system includes a plurality of the sensors.

Preferably, the detection system is capable of non-invasively analyzing the pharmaceutical composition in real-time during processing of the pharmaceutical composition.

In a preferred embodiment of the invention, the detection system is capable of determining at least one of the following composition parameters: the identity of each pharmaceutical composition constituent, the concentration of each pharmaceutical composition constituent, the homogeneity of the pharmaceutical composition and the density of the pharmaceutical composition.

The method of in-situ analysis of a pharmaceutical composition during processing, in accordance with one embodiment of the invention, comprises the steps of (i) providing a processing apparatus configured to process the pharmaceutical composition, (ii) providing a luminescence detection system operatively associated with the processing apparatus, the detection system including at least one luminescence sensor, the sensor being adapted and positioned to direct a plurality of radiation pulses to the pharmaceutical composition and detect the luminescence emitted from each constituent in the pharmaceutical composition, the sensor being further adapted to provide at least one luminescence signal corresponding to the detected luminescence of each constituent, and control means in communication with the sensor for controlling the sensor, (iii) illuminating the pharmaceutical composition with at least a respective one of the plurality of radiation pulses, (iv) detecting the luminescence emitted from each pharmaceutical composition constituent as a function of time, and (v) determining at least one characteristic of the pharmaceutical composition from the detected luminescence.

### EXAMPLES

The following examples are provided to enable those skilled in the art to more clearly understand and practice the present invention. They should not be considered as limiting the scope of the invention, but merely as being illustrated as representative thereof.

### Example 1

Four pharmaceutical samples were subjected to luminescence analysis in accord with the method of the time-domain method of the invention. The samples comprised: the following:
Sample 1—salmeterol
Sample 2—lactose formulation including salmeterol and fluticasone propionate
Sample 3—rosiglitazone
Sample 4—ramipril

Time correlated fluorescence decay (TCPD) curves for each sample were generated by inducing fluorescence with 336 nm (NanoLED-16) and 280 nm (NanoLED-15).

TCPD curves for Samples 1-3 were collected with 16 nm slits on emission. Data were integrated until 10,000 counts accumulated in the peak channel using 8192 channels of gain conversion at 6.945 ps/channel in the 50 ns TAC range. Typical acquisition time was 70 seconds for samples 1-3 (rep rate 1 MHz).

Sample 4 was excited using the 280 nm NanoLED with a 200 microsecond TAC range and a 10 kHz repetition rate. The acquisition time was 20 min.

Time-Resolved Emission Spectra (TRES) data of samples 1-3 were recorded at respective 10 nm intervals for 70 seconds per interval.

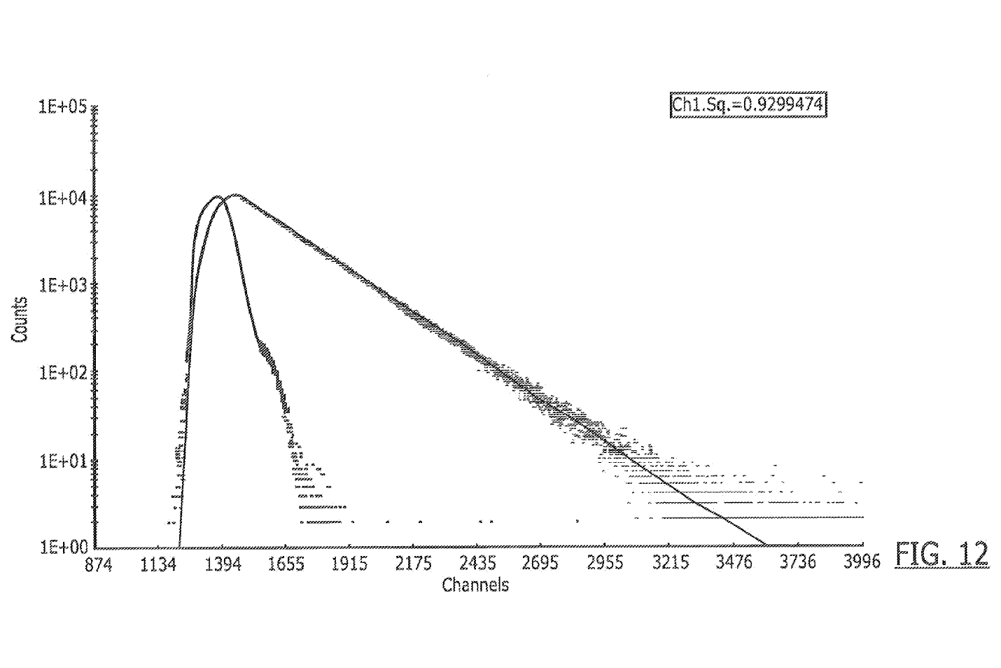

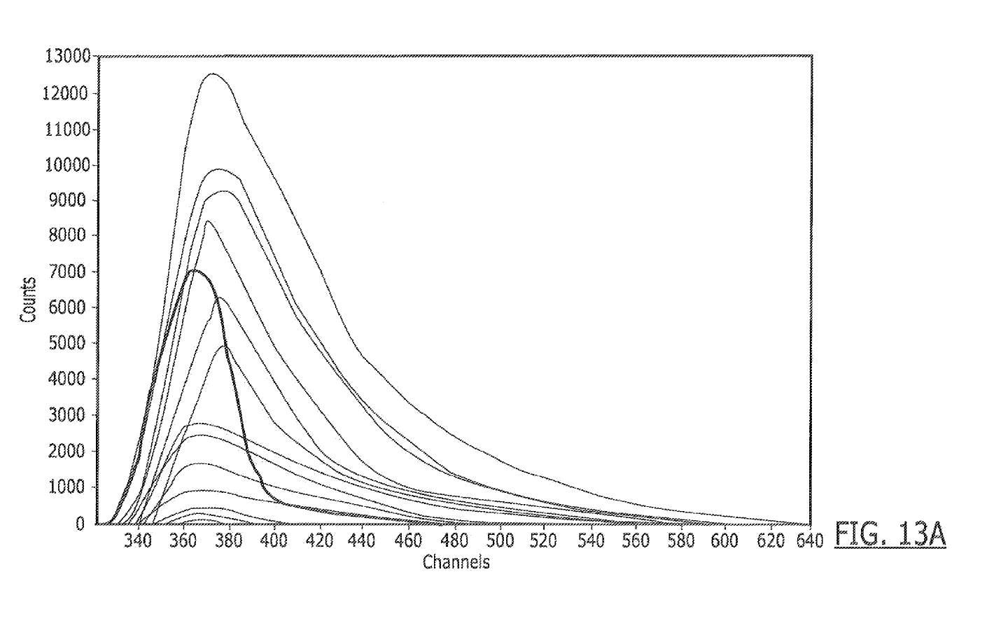

FIG. 10 reflects that Sample 1 was well fit to a triple exponential decay model (Chi-square=0.917). The two positive lifetime components were 1.41 and 1.31 ns. The TRES plots shown in FIGS. 11A and 11B reflect that the peak emission wavelength was around 415 nm.

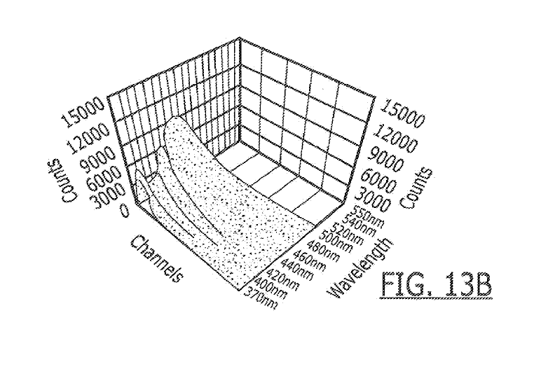

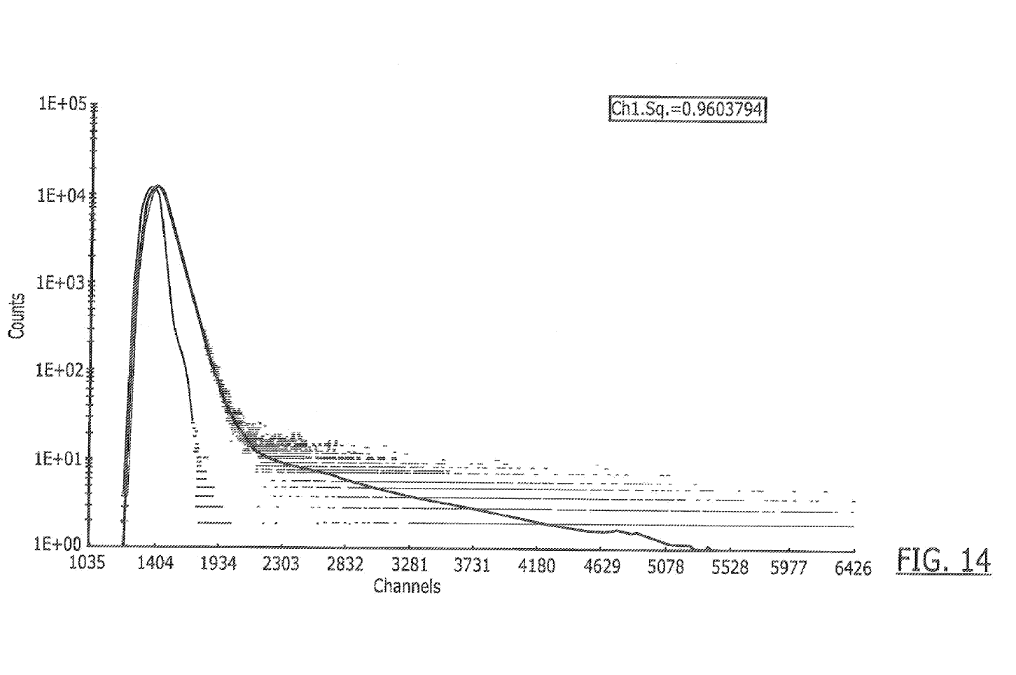

FIG. 12 reflects that Sample 2 was well fit to a triple exponential decay model (Chi-square=0.929). The two positive lifetime components were 1.43 and 1.48 ns. Samples 1 and 2 were overall very similar. The TRES plots shown in FIGS. 13A and 13B reflect that the peak emission wavelength was around 425 nm.

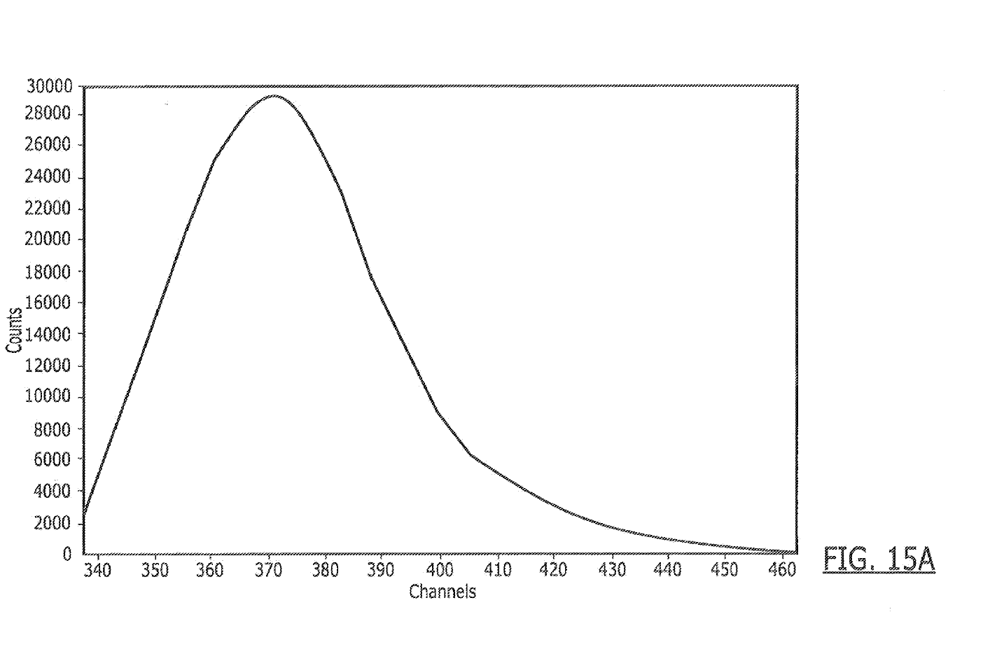

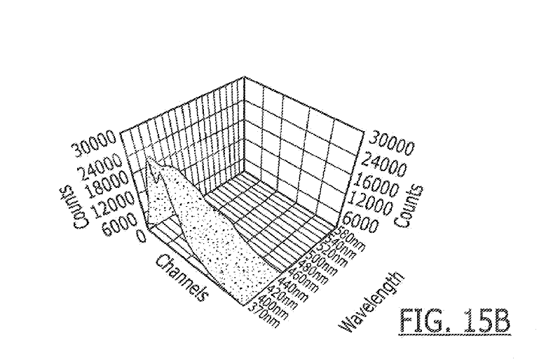

FIG. 14 reflects that Sample 3 was well fit to a triple exponential decay model (Chi-square=0.960). The three positive lifetime components were 0.396, and 0.645 ns with a small amplitude of a much longer component at around 8 ns. Sample 3 was also considerably blue shifted in emission compared to Samples 1 and 2. Furthermore, the lifetimes of the main components were significantly faster. The TRES plots shown in FIGS. 15A and 15B reflect that the peak emission wavelength was <370 nm.

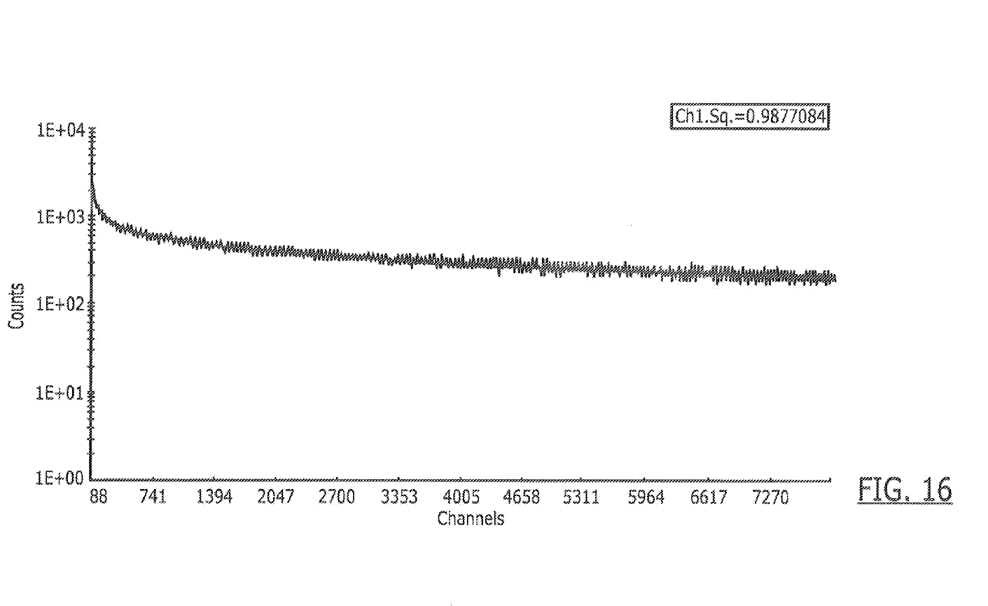

The decay curve for Sample 4 shown in FIG. 16 reflects that several long lifetime components and was well fit to a 4 exponential component mode (chi-square=0.987). The lifetimes were 0.011, 0.095, 0.6 and 4.29 microseconds.

As will be readily apparent to one having ordinary skill in the art, the present invention provides highly efficient and effective systems and methods for non-invasively determining the homogeneity of a pharmaceutical composition and/or the concentration of pharmaceutical composition constituents and/or the density of the pharmaceutical composition during processing. As a result, the process is not disturbed by the analysis and, hence, is generally not susceptible to sampling and measurement errors often associated with conventional invasive methods of analysis.

The luminescence methods of the invention also provide a unique and effect means of monitoring the physical property in materials during processing, which can not be achieved in any other manner. Indeed, it is known in the art that salmeterol interacts with fluticasone propionate and/or lactose during blending of the noted components. The most likely interaction and, hence, change is produced by an electrostatic change causing a shift in both the spectral domain (˜415-425 nm) and, more importantly, the time domain (it takes longer for the photon to complete the relaxation). By virtue of the luminescence methods of the invention, the physical property change(s) can be readily detected during processing.

The luminescence methods and systems of the invention can also be employed on-line and in real-time to provide compositional information, including property changes (as discussed above), during processing. This permits adjustment of processing variables and/or processing apparatus to optimize processing of the pharmaceutical processing. The luminescence sensors of the invention also provide a strong signal, which enables the sensors, and systems and methods employing same, of the invention to detect trace elements at low concentrations. The higher specificity further facilitates highly accurate identification of pharmaceutical composition constituents.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A system for analyzing a pharmaceutical composition having at least one constituent, comprising:
a luminescence sensor having an integral low current light source, said sensor being adapted to direct a plurality of radiation pulses to the pharmaceutical composition and detect luminescence emitted from the constituent, said sensor being further adapted to provide at least one luminescence signal representing said detected luminescence; and
control means in communication with said sensor for controlling said sensor and analyzing said luminescence signal.

2. The system of claim 1, wherein said sensor is operable with a power input in the range of approximately 5-25 volts.

3. The system of claim 1, wherein said light source comprises a plurality of light emitting diodes.

4. The system of claim 3, wherein said light source comprises four light emitting diodes.

5. The system of claim 3, wherein each of said light emitting diodes comprises a blue light emitting diode.

6. The system of claim 3, wherein each of said light emitting diodes is adapted to transmit light having a wavelength in the range of approximately 300-650 nm.

7. The system of claim 3, wherein each of said light emitting diodes has a power output in the range of approximately 2-5 milliwatts.

8. The system of claim 1, wherein said sensor includes a pulse generating circuit adapted to provide a pulsed cycle power input to said light source in the range of approximately 1-1000 Hz.

9. The system of claim 8, wherein said pulse generating circuit provides a pulsed cycle power input to said light source in the range of approximately 4-100 Hz.

10. The system of claim 2, wherein said control means includes a control module adapted to control the activation of and said power input to said sensor, and an analyzer adapted to analyze said luminescence signal.

11. The system of claim 10, wherein said control means further includes storage means for storing said luminescence signal and at least one luminescence value representing at least one luminescence characteristic of a predetermined constituent.

12. A system for processing a pharmaceutical composition having at least one constituent, comprising:
a processing apparatus configured to process the pharmaceutical composition; and
a luminescence detection system operatively associated with said processing apparatus, said detection system including at least one luminescence sensor having an integral low current light source, said sensor being adapted to direct a plurality of radiation pulses to the pharmaceutical composition and detect luminescence emitted from the constituent, said sensor being further adapted to provide at least one luminescence signal representing said detected luminescence, and control means in communication with said sensor for controlling said sensor and analyzing said luminescence signal.

13. The system of claim 12, wherein said processing apparatus comprises a mixing apparatus.

14. The system of claim 12, wherein said processing apparatus comprises a fill apparatus.

15. The system of claim 12, wherein said processing apparatus comprises an apparatus adapted to transport the pharmaceutical composition during processing.

16. The system of claim 12, wherein said detection system includes a plurality of said sensors.

17. The system of claim 12, wherein said detection system is adapted to non-invasively analyze the pharmaceutical composition in real-time during processing of the pharmaceutical composition.

18. The system of claim 12, wherein said detection system is adapted to determine the identity of the pharmaceutical composition constituent.

19. The system of claim 12, wherein said detection system is adapted to determine the concentration of the pharmaceutical composition constituent.

20. The system of claim 12, wherein said detection system is adapted to determine the density of the pharmaceutical composition.

21. The system of claim 12, wherein the pharmaceutical composition includes at least one active constituent selected from the group consisting of salbutamol, salmeterol, budesonide, a beclomethasone ester and fluticasone ester.

22. A method of in-situ analysis of a pharmaceutical composition during processing, the pharmaceutical composition having at least one constituent that emits luminescence in response to applied radiation, the method comprising the steps of:
providing a processing apparatus configured to process the pharmaceutical composition;
providing a luminescence detection system operatively associated with said processing apparatus, said detection system including at least one luminescence sensor having an integral low current light source, said sensor being adapted and positioned to direct a plurality of radiation pulses to the pharmaceutical composition and detect the luminescence emitted from the constituent, said sensor being further adapted to provide at least one luminescence signal representing said detected luminescence, and control means in communication with said sensor for controlling said sensor;
illuminating the pharmaceutical composition with at least a respective one of said plurality of radiation pulses;
detecting said luminescence emitted from the pharmaceutical composition constituent; and
determining at least one characteristic of the pharmaceutical composition from said detected luminescence.
